(19) United States
(12) Patent Application Publication
(10) Pub. No.: US 2026/0264995 A1
(43) Pub. Date: Sep. 10, 2026

(54) STACKING COLUMN FOR HOLDING STORAGE PARTS

(71) Applicant: MTS Maschinenbau GmbH, Mengen (DE)

(72) Inventor: Eckhard LAIBLE, Leinfelden-Schlechtenmühle (DE)

(21) Appl. No.: 19/557,420

(22) Filed: Mar. 5, 2026

(30) Foreign Application Priority Data
Mar. 5, 2025 (DE) 10 2025 108 266.9

(51) Int. Cl. B65G 1/14

(52) U.S. Cl. CPC B65G 1/14

(57) ABSTRACT

A stacking column for holding at least two bearing parts on a single stacking pawl (1), includes a base body (2) having two side walls (3, 4) connected to each other by a rear wall (5), the two side walls (3, 4) form a channel shape with the rear wall (5), the stacking pawls (1) are arranged between the two side walls (3, 4) in the channel shape, wherein each of the stacking pawls (1) is assigned an axle bolt (6) and a linkage bolt (7), wherein the linkage bolt (7) is movably guided within two arcuate elongated holes (8.1, 8.2), wherein the elongated holes (8.1, 8.2) are each embedded in one of the side walls (3, 4), and the axle bolt (6) is rotatably mounted between the two side walls (3, 4) and in bores (9.1, 9.2) of the side walls (3, 4), a return spring (10) arranged around the axle bolt (6), a first spring leg (11.1) of which presses against the rear wall (5) and a second spring leg (11.2) is arranged to push the linkage bolt (7) back to a rest position, wherein a radial spring (12) connects the linkage bolt (7) and the axle bolt (6) and is arranged to pull the linkage bolt (7) towards the axle bolt (6), thereby pulling the linkage bolt (7) towards an inner contour (13) of the elongated holes (8.1, 8.2) facing the axle bolt (6), wherein the inner contour (13) forms a break in the course (16) protruding away from the axle bolt (6) between a rest position and a working position.

### BACKGROUND OF THE INVENTION

The invention relates to a stacking column for holding storage parts.

Such stacking columns or latches integrated therein are known, for example, from DE 38 11 310 C2. In most cases, these are vertical stacking columns arranged in a square. For technical reasons, however, it may also be advisable to arrange these stacking columns at an angle, as shown in DE 41 33 464 A1. Furthermore, there is also the possibility of horizontal arrangement of the stacking column, for example according to DE 40 20 864 A1.

In all of these stacking columns, the stored goods rest in or on support arms of ratchet levers, which carries the risk of the stored goods being displaced. This disadvantage has a particularly significant negative effect when the stacking columns are designed to be transportable. Shifting on the support arms can also cause damage to the stored goods. Therefore, attempts are made to secure the stored goods on the stacking columns in addition to. According to DE 196 47 578 A1, this can be achieved by providing an intermediate pawl between two adjacent pawl levers, which, after the stored goods have been placed on or against one pawl lever, can be placed on or against the stored goods on the other side of the one pawl lever by the swiveling movement of another pawl lever.

Furthermore, in many stacking columns, the successive pawls are connected to each other via a linkage so that their movement is dependent on each other. In the working position, these pawls are then held only by the linkage or the stored goods.

### SUMMARY OF THE INVENTION

The purpose of the present invention is to provide a stacking column for receiving stored goods, in which more than one stored good can be placed on a single stacking pawl, and in which loading can take place in a possibly multi-stage, i.e., sequential manner, without the stacking pawl pivoting from the standby position for loading the stacking pawl into the working position as an indication of complete loading when the first stored item is loaded, but rather remaining in the standby position until a defined number of stored items press against the stacking pawl.

The features disclosed herein provide a solution to the problem. Advantageous embodiments are also described herein and in the subclaims.

The stacking column according to the invention for receiving stored goods on a single stacking pawl is designed in such a way that the stacking pawl is moved from a rest position to a standby position. In order to place stored goods on top of or next to each other at defined intervals on a stacking pawl, several stacking pawls are used, which are arranged either on top of or next to each other. These stacking pawls are mounted in a swiveling manner within the channel shape between the two side walls.

The stacking clamps are connected to each other via a linkage that engages with the linkage bolt. The linkage ensures that the movement of a stacking clamp is controlled: as soon as a stacking clamp reaches the working position, i.e., is loaded, the adjacent stacking clamp is moved from the rest position to the standby position. The standby position indicates that the stacking pawl is ready for the next load.

The stacking clamps are moved by the linkage, which controls their position between the rest position, standby position, and working position. The linkage is connected to the linkage bolt. The first or lowest stacking pawl is an exception, as it is not usually in a rest position, but only switches between the standby position and the working position. It is located directly on the base plate and always remains in one of these two positions. In cases where there is no base plate, the first stacking pawl mentioned above is the pawl to be loaded first.

Until now, it was common practice to place stored goods on a stacking pawl in a single loading process. Multi-stage loading, in which several stored goods are placed one after the other on a single stacking pawl, was not possible. However, this was not the most efficient approach, as in practice stored goods are often produced one after the other or removed from a manufacturing machine and then deposited.

The stacking column according to the invention now enables a multi-stage loading process. This means that a predetermined number of identical stored goods can usually be placed on a single stacking pawl. In addition, it is also possible, for example, to place different stored goods on a single stacking pawl.

The stacking column consists of a base body with two side panels connected by a rear wall. The stacking clamps are mounted on an axle bolt between the two side panels so that they can rotate. Together with the rear wall, these side panels form a channel shape, which can optionally include a base plate. The base plate can be fixed to a surface, for example, the floor of a factory hall, a storage trolley, or a pallet.

Each stacking pawl has a linkage bolt that can move within a straight or curved slotted hole in the side panel. This mobilizes the stacking pawl and at the same time provides its attachment point for the linkage that controls the movement between the standby and working positions. In the embodiment described, the linkage bolt is guided within two curved slotted holes, each of which is embedded in the side plates. The axle bolt, in turn, is mounted between the side plates and rotates within corresponding bores.

A return spring is arranged around the axle bolt to return the stacking pawl. Its first spring leg presses against the rear wall, while its second spring leg returns the linkage bolt to the rest position. This means that the return spring uses its force to press the stacking pawl into the rest position, while the weight of the stored goods exerts an opposite force on the stacking pawl.

In addition to a linkage bolt, each stacking pawl also has an axle bolt. These bolts are not part of the stacking pawl itself, but serve its function.

A significant innovation of the invention is the use of a radial spring that connects the linkage bolt to the axle bolt. This radial spring pulls the linkage bolt toward the axle bolt and at the same time ensures that the linkage bolt is constantly pressed against the inner contour of the arched slots. This enables controlled movement of the linkage bolt and thus also of the stacking pawl. It is crucial for the function that the inner contour between the rest position and the working position of the linkage bolt has an interruption in its progression. One possible design for the interruption in progression can be a protruding bead that stands away from the axle bolt. However, it can also be a step that divides the course of the inner contour into two sections. A first section away from the rest position to the interruption in the course and a second section from the interruption in the course to the working position. For example, the first section runs closer to the axle bolt and the second section rises and runs further away from the axle bolt. In addition, there may also be a recess or recess pocket into which the linkage bolt moves toward the axle bolt and out of again after overcoming the interruption in the course. Hybrid forms of this are also possible.

This interruption breaks the curved line of the inner contour and allows the stacking pawl to be loaded in several stages. In combination with the radial spring, which constantly presses the linkage bolt against the inner contour, the interruption acts as an obstacle to be overcome. This obstacle is overcome as soon as a defined load is applied to the stacking pawl. However, by definition, a progression interruption also occurs when there is a recessed pocket between the rest position and the working position that is drawn toward the axle bolt, into which the linkage bolt retracts in the standby position, briefly stops, and then continues to the working position after the stacking pawl has been sufficiently loaded.

The multi-stage loading process results from the fact that the obstacle of the interruption in movement is only overcome when the previously specified weight of the stored goods is reached. Only when the force exerted on the stacking pawl exceeds the defined force of the radial spring does the linkage bolt slide over the interruption and change from the standby position to the working position. At the same time, the next stacking pawl is moved from the rest position to the standby position.

The progression interruption is arranged within the inner contour between a rest position recess and a working position recess.

In an alternative embodiment, the second spring leg of the return spring can protrude between the linkage bolts and the stacking pawl.

This progression corresponds to the typical pattern of the arc-shaped elongated hole and thus also to the inner contour. However, it is interrupted by the progression interruption, which has a larger radial distance from the bore of the axle bolt. Apart from the interruption in the progression, the inner contour can have a basic radial distance of 15 mm to 85 mm. This allows the designer to determine, depending on the distance, how much weight is required to guide the linkage bolt over the interruption in the progression. A greater distance requires greater force and thus a higher weight of the stored goods.

In addition, the force required to overcome the break in the course can be adjusted by using several radial springs. There may be an additional radial spring which, together with the first radial spring, flanks the return spring at the ends of the axle bolt. This ensures even force distribution and prevents long-term unilateral loads on the axle bolt or linkage bolt.

In addition, further interruptions in the contour may be formed on the inner contour in addition to one interruption in the contour. This gives the designer the opportunity to specifically calculate and control multi-stage loading processes.

One possible embodiment of a stacking pawl according to the invention consists of a bearing arm and a guide receptacle. The guide mount consists of a base area and two wings arranged at right angles, each of which has two axle bolt holes and two guide bolt slots. In addition, two guide bolt slots are formed parallel to a bend in the base area that transitions to the wings. The bearing arm may also be provided with an additional plastic coating.

### BRIEF DESCRIPTION OF THE DRAWINGS

Further advantages, features, and details of the invention are apparent from the following description of preferred embodiments and from the drawings, which show in:

FIG. 1 shows a stacking column (S) in perspective from a first perspective from above at an angle.

FIG. 2 shows the stacking columns (S) from FIG. 1 from a second perspective from above at an angle.

FIG. 3 shows a partial view of the stacking column (S) from a first perspective.

FIG. 4 shows the partial view of FIG. 3 from a second perspective.

FIG. 5 shows a mere side view of one of the side cheeks without any other components.

FIG. 6 shows the view from FIG. 5 with additional components in a rest position of the stacking pawl (S).

FIG. 7 shows the view from FIG. 5 with additional components in a standby position of the stacking pawl.

FIG. 8 shows the view from FIG. 5 with additional components in a working position of the stacking pawl.

### DETAILED DESCRIPTION

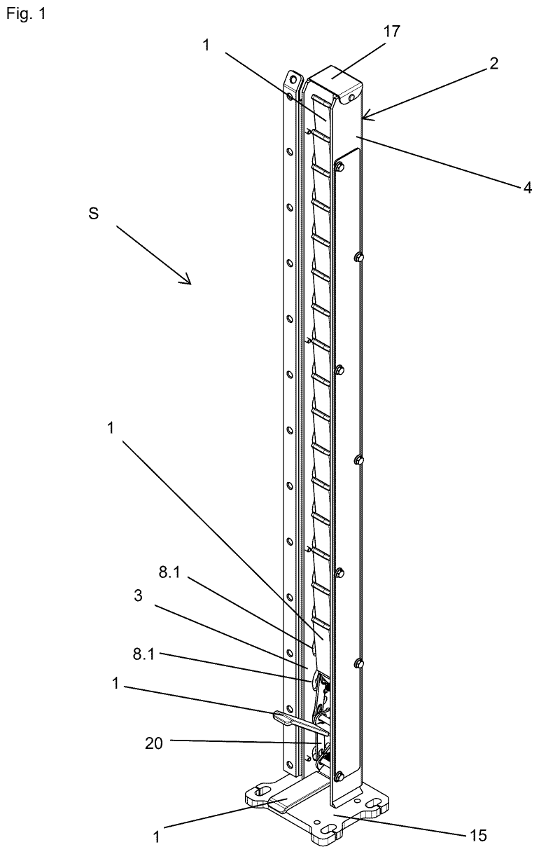

FIG. 1 shows a stacking column S in perspective from a first perspective from above at an angle. The stacking column S serves to hold storage parts on a stacking pawl 1. The stacking column S primarily consists of a base body 2, which in turn consists of a first side wall 3 and a second side wall 4. At one end, the base body 2 has a base plate 15. At the other end, the base body 2 is closed off with a cover plate 17. The base body 2 forms a channel shape in which several stacking latches 1 are arranged one above the other. The first stacking latch 1 near the base plate 15 is in the working position. The stacking latch 1 located above it in the direction of the cover plate 17 is in the standby position. The remaining stacking latches 1 are in the rest position. Since the first perspective view shows part of the inside of the first side wall 3, a linkage 20 and the first arched elongated holes 8.1 can be seen there. The first arched elongated holes 8.1 are recesses in the first side wall 3.

The linkage 20 effectively connects the stacking latches 1 arranged in the base body 20 in such a way that whenever one first stacking latch 1 moves, the adjacent second stacking latch 1 is also activated. This occurs in the sequence of rest position to standby position to working position and back. The only exception to this is the stacking pawl 1 closest to the base plate 15, which is not in the rest position in the initial position, but already in the standby position, and only returns to this standby position.

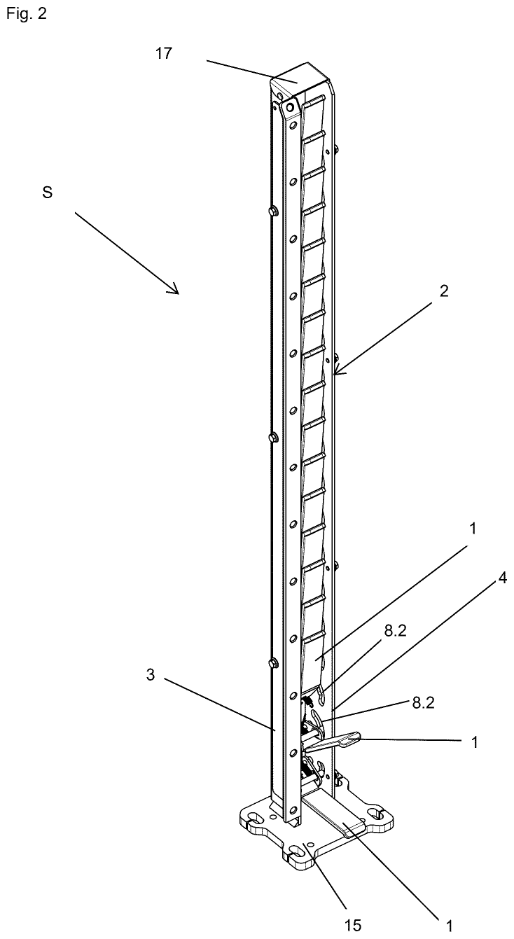

FIG. 2 shows the stacking columns S from FIG. 1 from a second perspective from above at an angle. The explanations given for FIG. 1 also apply to this FIG. 2. From this perspective, the inside of the base body 2 can be partially seen. Consequently, second arched elongated holes 8.2 can also be seen, which are recessed into the second side wall 4 as recesses.

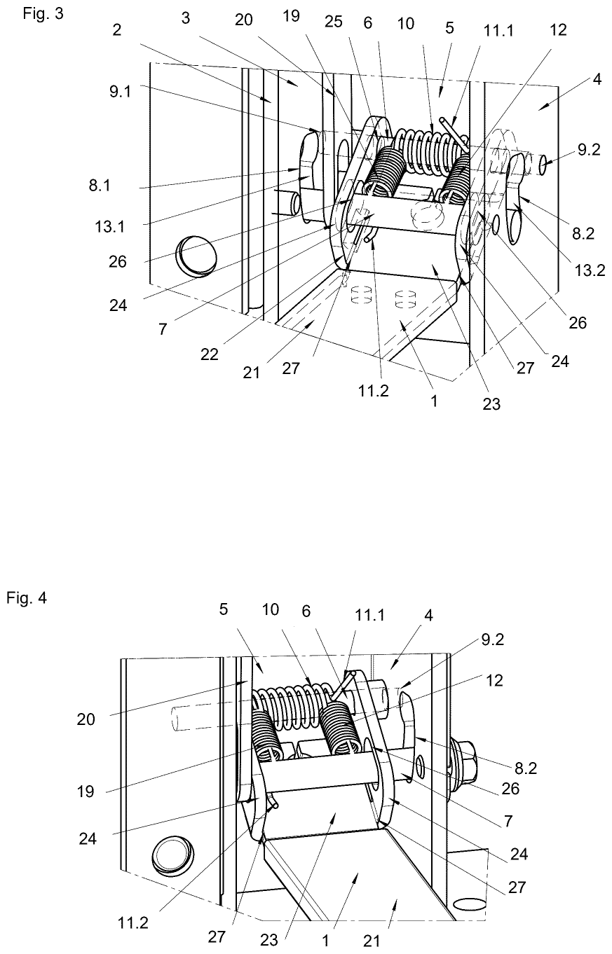

FIG. 3 shows a partial perspective view of the stacking column S according to the invention. The stacking pawl 1 shown in FIG. 3 is the stacking pawl 1 closest to the base plate 15.

The stacking pawl 1 is arranged within the channel shape of the base body 2. The base body 2 consists primarily of the two side walls 3, 4, which are connected to each other via a rear wall 5. Further stacking pawls 1, which are not shown, are also arranged between the two side walls 3, 4 in the channel shape, either one above the other or next to each other, so that they can be pivoted.

The stacking pawl 1 is assigned a pivot pin 6 and a linkage pin 7.

The linkage bolt 7 is movably guided within the two arched elongated holes 8.1, 8.2. The arched elongated holes 8.1, 8.2 are each embedded in one of the side panels 3, 4. Specifically, the first curved elongated hole 8.1 is embedded in the first side wall 3. The second curved elongated hole 8.2 is embedded in the second side wall 4.

The axle bolt 6 is arranged between the two side plates 3, 4 and is rotatably mounted in bores 9.1, 9.2 of the side plates 3, 4. The first bore 9.1 is embedded in the first side plate 3 and the second bore 9.2 is embedded in the second side plate 4.

A return spring 10 is arranged around the axle bolt 6. A first spring strut 11.1 presses against the rear wall 5. A second spring strut 11.2 is arranged in such a way that it pushes the linkage bolt 7 into a rest position.

Radial springs 12, 19 are also shown, connecting the linkage bolt 7 and the axle bolt 6.

The radial spring 12 and the further radial spring 19 are arranged so that they pull the linkage bolt 7 toward the axle bolt 6. In the embodiment shown here, the radial spring 12 and the other radial spring 19 are arranged so that they flank the return spring 10 at the axle bolt 6 at each end.

The radial springs 12 shown pull the linkage bolt 7 toward an inner contour 13.1, 13.2 of the arched elongated holes 8.1, 8.2 facing the axle bolt 6. Specifically, the first inner contour 13.1 is part of the first curved elongated hole 8.1 and the second inner contour 13.2 is part of the second curved elongated hole 8.2.

The explanations given here also apply to the other stacking pawls 1 located in the stacking column S, whereby the other stacking pawls 1 are moved in arc-shaped elongated holes 8.1, 8.2 which have an interruption 16 in their course.

Figures three to six clearly show that the inner contour 13.1, 13.2 runs between the rest position and the working position of the stacking pawl 1. It forms the interruption 16 in the form of a protruding bead that protrudes from the axle bolt 6 and the bores 9.1, 9.2 into which the axle bolt 6 engages. The interruption 16 in the course of the stacking pawl 1 from the rest position to the working position forms a resistance that enables multi-stage loading of the stacking pawl 1 in the standby position.

In another embodiment not shown, the interruption 16 in the inner contour 13 is arranged between a rest position recess for the rest position of the stacking pawl 1 and a working position recess for the working position of the stacking pawl 1. The rest position recess and the working position recess are pockets embedded in the respective arc-shaped elongated holes 8.1, 8.2 at the end and protruding in the direction of the bores 9.1, 9.2, which are intended to prevent the rod bolt 7 from slipping out unintentionally.

FIGS. 3 and 4 clearly show that the second spring strut 11.2 protrudes between the linkage bolts 7 and the stacking pawl 1. It is also clear that the stacking pawls 1, which are arranged one above the other or next to each other, are connected to each other via a linkage 20, engaging with the linkage bolt 7.

The stacking pawl 1 in turn consists of a bearing arm 21 and a guide receptacle 22. The guide receptacle 22 consists in detail of a base area 23 and two wings 24 arranged at right angles, whereby the wings 24 have two axle bolt holes 25 and two guide bolt slots 26.

The two guide bolt slots 26 run parallel to a bend 27 that connects the base section 23 to the wings 24. This arrangement ensures precise guidance and stability of the moving components.

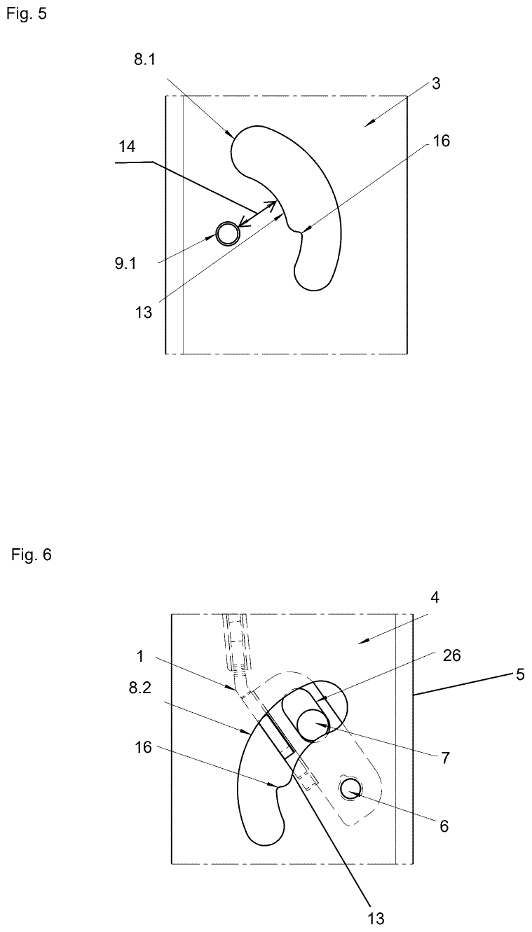

FIG. 5 also shows how a radial distance 14 is created. The inner contour 13 has a substantially arcuate radial distance 14 of 15 mm to 85 mm from the holes 9.1, 9.2 of the axle bolt 6. The inner contour 13 of the arcuate elongated hole 8.1 has a predominantly arcuate distance of 15 mm to 85 mm from the bore 9.1 of the axle bolt 6. The curved path begins at the 12 o'clock position, starting from the hole 6 in the side wall 3, into which the axle bolt 6 engages, and ends between the 4 o'clock and 5:30 o'clock positions in relation to this hole 9.1. The same applies, of course, to the opposite side wall 4 and the curved elongated hole 8.2 and hole 9.2 located there.

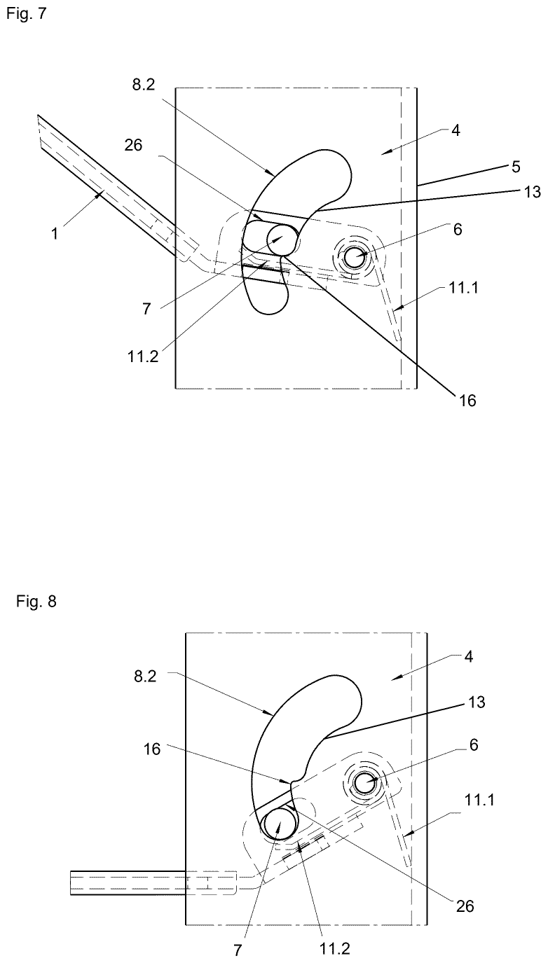

FIG. 6 shows the stacking pawl 1 in its rest position. The linkage bolt 7 is located near the rear wall 5 and slides counterclockwise in the arched elongated hole 8.2 to the standby position shown in FIG. 7. There, the movement of the linkage bolt 7 is stopped in a defined manner by the inner contour 13. As soon as the stacking pawl 1 has been loaded according to the specifications, the linkage bolt 7 overcomes the force of the radial springs 12, 19, passes the interruption 16, and slides into the working position, as shown in FIG. 8.

List of reference symbols

| | |
|---|---|
| 1 | Stack pawl |
| 2 | Base body |
| 3 | First side plate |
| 4 | Second side panel |
| 5 | Rear panel |
| 6 | Axle bolt |
| 7 | Linkage bolt |
| 8.1, 8.2 | Arc slot |
| 9.1, 9.2 | Bore |
| 10 | Return spring |
| 11 | First spring strut |
| 12 | Radial spring |
| 13.1. 13.2 | Inner contour |
| 14 | Radial distance |
| 15 | Base plate |
| 16 | Interruption of flow |
| 17 | Cover plate |
| 19 | additional radial spring |
| 20 | linkage |
| 21 | Bearing arm |
| 22 | Guide mount |
| 23 | Bottom area |
| 24 | Wing |
| 25 | Axle bolt hole |
| 26 | Guide bolt slot |
| 27 | Kink |
| 28 | |
| 29 | |
| 30 | |
| 31 | |
| 32 | |
| 33 | |

What is claimed is:

1. Stacking column for holding bearing parts on a stacking pawl (1), comprising:
a base body (2) having two side walls (3, 4) connected to each other by a rear wall (5),
wherein the two side walls (3, 4) form a channel shape with the rear wall (5),
wherein stacking pawls (1) are arranged between the two side walls (3, 4) in the channel shape so that they can pivot over one another,
wherein each stacking pawl (1) is assigned an axle bolt (6) and a linkage bolt (7),
wherein the linkage bolt (7) is movably guided within two arcuate elongated holes (8.1, 8.2),
wherein the elongated holes (8.1, 8.2) are each embedded in one of the side walls (3, 4), and
the axle bolt (6) is rotatably mounted between the two side walls (3, 4) and in bores (9.1, 9.2) in the side walls (3, 4),
wherein a return spring (10) is arranged around the axle bolt (6), a first spring leg (11.1) of which presses against the rear wall (5) and a second spring leg (11.2) of which is arranged to push the linkage bolt (7) back into a rest position,
wherein:
a radial spring (12) connects the linkage bolt (7) and the axle bolt (6), and
the linkage bolt (7) is arranged to pull toward the axle bolt (6), thereby pulling the linkage bolt (7) toward an inner contour (13) of the elongated holes (8.1, 8.2) facing the axle bolt (6),
wherein the inner contour (13) forms an interruption (16) between the rest position of the stacking pawl (1) and a working position of the stacking pawl (1).

2. Stacking column according to claim 1, wherein the interruption (16) forms a protruding bead that at least partially protrudes from the axle bolt (6).

3. Stacking column according to claim 1, wherein the overcoming bead (16) of the inner contour (13) has a rest position recess between a rest position and a working position recess.

4. Stacking column according to claim 1, wherein the second spring leg (11.2) protrudes between the linkage bolt (7) and the stacking pawl (1).

5. Stack column according to claim 1, wherein the inner contour (13) has a substantially arcuate distance of 15 mm to 85 mm from the bores (9.1, 9.2).

6. Stacking column according to claim 1, wherein a further radial spring (19) is provided, wherein the radial spring (12) and the further radial spring (19) flank the return spring (10) at the axle bolt (6) at each end.

7. Stacking column according to claim 1, wherein the inner contour (13) forms further overcoming beads.

8. Stacking column according to claim 1, wherein the stacking pawls (1) are operatively connected to each other via a linkage (20) engaging with each other on the linkage bolt (7).

9. Stacking column according to claim 1, further comprising a bearing arm (21) and a guide receptacle (22), wherein the guide receptacle (22) consists of a base area (23) and two wings (24) arranged at right angles, wherein the wings (24) having two axle bolt holes (25) and two guide bolt slots (26).

10. Stacking column according to claim 9, wherein the two guide bolt slots (26) are formed parallel to a bend (27) of the base section (23) towards the wings (24).

11. Stacking column according to claim 1, wherein the bearing arm (21) has a plastic coating.
